(19) United States
(12) Patent Application Publication
(10) Pub. No.: US 2009/0115157 A1
(43) Pub. Date: May 7, 2009

(54) LEAF SPRING END MOUNT INTERFACE

(76) Inventors: David K. Platner, Shelby, MI (US); Arnett R. Weber, Burlington (CA); Rajesh J. Somnay, Troy, MI (US); Holly Ann Giangrande, Troy, MI (US); Tomaz Dopico Varela, Shelby Township, MI (US); Brian J. Knouff, Dayton, OH (US); Benjamin R. Reineck, Waterford, MI (US); Norman D. Austin, Kurztown, PA (US); John E. Mutzner, Covington, OH (US)

Correspondence Address: CARLSON, GASKEY & OLDS, P.C., 400 WEST MAPLE ROAD, SUITE 350, BIRMINGHAM, MI, 48009, US

(21) Appl. No.: 11/936,121

(22) Filed: Nov. 7, 2007

(51) Int. Cl. B60G 11/04

(52) U.S. Cl. 280/124.176

(57) ABSTRACT

A leaf spring for a vehicle suspension is formed from a composite material and includes a central portion to be supported by an axle and at least one free end that extends from the central portion in a longitudinal direction. The free end is coupled to a vehicle structure via a slider bracket. A contact element is mounted to the slider bracket to contact an upper surface of the free end to accommodate vertical forces. The free end is slidably movable relative to the contact element along a longitudinal axis and is pivotable relative to the contact element about a lateral axis.

### TECHNICAL FIELD

The subject invention relates to a composite leaf spring for a vehicle suspension having an improved end mount interface for connection to a vehicle structure.

### BACKGROUND OF THE INVENTION

Vehicle suspensions include springs that cooperate with other suspension components to improve ride and handling characteristics for a vehicle. One type of suspension is a front axle suspension that uses one or more leaf springs formed from steel. In this suspension configuration, the leaf spring has a free end coupled to a shackle assembly, which is mounted to a vehicle structure. This conventional shackle mount interface accommodates longitudinal displacement due to flexing under load as the leaf spring moves from a curved condition towards a flat condition. A typical shackle assembly is comprised of several plates, two bushings, and a bracket.

Trailer suspensions utilize a sliding end bracket configuration to accommodate longitudinal displacement. This is effective for trailer applications but has a disadvantage of having lateral gaps at sides of the leaf spring, resulting in lateral slack. In steering applications, lateral gaps cause objectionable steering center feel due to low central lateral stiffness, and have objectionable noise and clattering due to lateral and vertical free play. Lateral play may initially be set to zero by using a bolt to clamp sides of a slider bracket; however, lateral play develops as components wear.

Another sliding end configuration uses a cam that is attached to a bracket in a vehicle frame or chassis. The cam supports a vertical force experienced by the leaf spring. In conventional configurations, the leaf spring and the cam are both formed from steel, and due to the stiffness of the cam, a very high contact pressure is created, which can result in premature wear of the cam or leaf spring.

Some suspensions utilize composite leaf springs instead of using traditional steel leaf springs in order to reduce weight. The existing solutions discussed above for free end mounting of steel leaf springs do not perform well for front axle applications. Further, these existing solutions would be very expensive to incorporate into composite springs.

Thus, there is a need for an improved mounting interface for composite leaf springs that overcomes the deficiencies in the prior art discussed above.

### SUMMARY OF THE INVENTION

A leaf spring for a vehicle suspension is formed from a composite material and includes a central portion to be supported by an axle and at least one free end that extends from the central portion in a longitudinal direction. The free end is coupled to a vehicle frame or chassis with a slider bracket. A contact element is fixed to the slider bracket to contact an upper surface of the free end to accommodate vertical forces. The free end is slidably movable relative to the contact element along a longitudinal axis and is pivotable relative to the contact element about a lateral axis.

In one disclosed embodiment, the contact element comprises a cam that is formed as part of the slider bracket. In one example, the cam is comprised of an elastomeric material that is covered with a layer of wear resistant material. The cam can include a curved surface that contacts the free end of the leaf spring or can comprise a pivoting cam coupled to a pivot pin, for example. In another example, the cam comprises an upper roller and a lower roller that are formed from materials that have different stiffness properties.

In one disclosed embodiment, the cam extends over the upper surface of the free end and laterally spaced pads are attached to legs of the slider bracket. The laterally spaced pads are positioned at opposing lateral edges of the free end of the leaf spring. In one example, the pads are formed from an elastomeric material and are covered with a layer of wear resistant material. The pads provide increased lateral stiffness.

In one disclosed embodiment, the contact element comprises a resilient block that extends over the upper surface of the leaf spring. The resilient block is formed from an elastomeric material and includes a plurality of laterally extending holes that are formed within a body of the resilient block in a pattern that is distributed away from a center of the resilient block. This provides a desired level of vertical stiffness.

These and other features of the present invention can be best understood from the following specification and drawings, the following of which is a brief description.

### BRIEF DESCRIPTION OF THE DRAWINGS

FIG. 1 is a schematic view of a suspension with a composite leaf spring assembly incorporating the subject invention.

FIG. 2 is one example of a composite leaf spring and slider bracket assembly.

FIG. 3 is another example of a composite leaf spring and slider bracket assembly.

FIG. 4 is another example of a composite leaf spring and slider bracket assembly.

FIG. 5 is another example of a composite leaf spring and slider bracket assembly.

FIG. 6 is another example of a composite leaf spring and slider bracket assembly.

FIG. 7 is another example of a composite leaf spring and slider bracket assembly.

### DETAILED DESCRIPTION OF THE PREFERRED EMBODIMENT

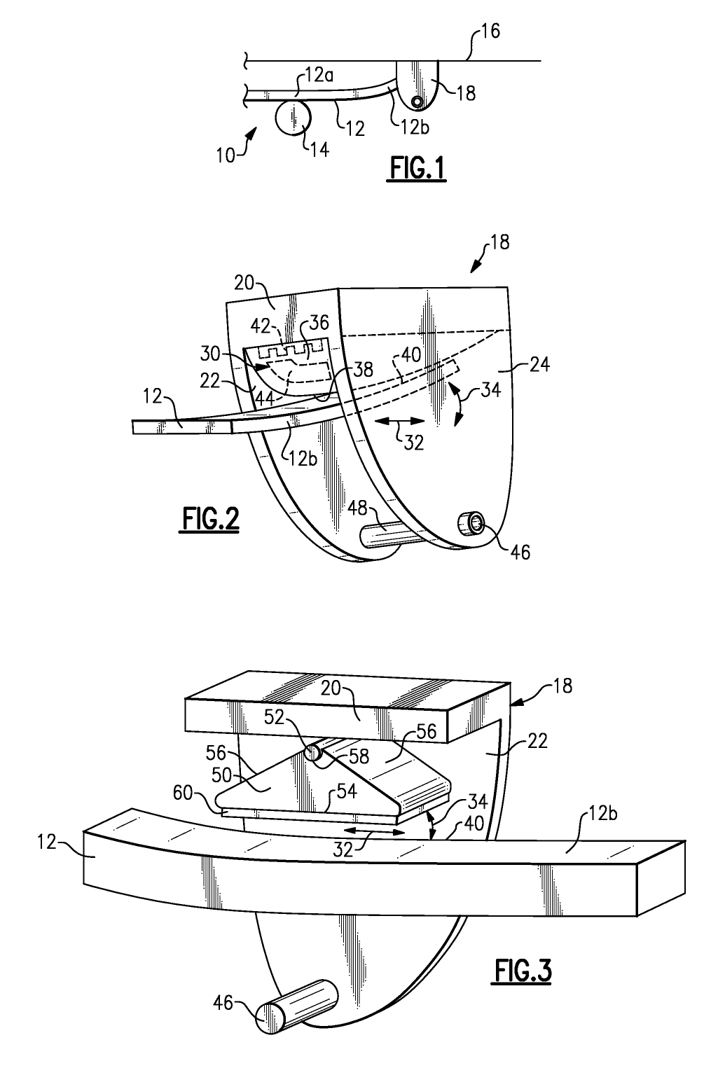

A suspension assembly 10 is shown schematically in FIG. 1. The suspension assembly includes one or more leaf springs 12 that are formed from a composite material. Forming the leaf spring 12 from a composite material has the advantage of decreased weight when compared to traditional steel leaf springs. Any type of composite material suitable for leaf springs can be used.

The leaf spring 12 extends in a longitudinal direction along a vehicle length and includes a central portion 12a that is supported on an axle 14 and a free end 12b that extends away from the central portion 12a in the longitudinal direction. The central portion 12a is not defined as a center of the leaf spring but may incorporate such an area. Further, the central portion 12a is descriptive of a spring portion that is located anywhere between ends of the leaf spring, and which is associated with the axle 14.

The free end 12b is coupled to a vehicle structure 16, such as a frame member or chassis for example, with a slider bracket 18. The axle 14 supports wheels (not shown) and extends in a lateral direction across a vehicle width. The axle 14 can be a front, rear, or trailer axle and further can be a steer, drive, or non-drive axle that includes a beam, housing, or axle tube, for example.

The slider bracket 18 is shown in greater detail in FIG. 2. The slider bracket 18 includes a base portion 20 and first 22 and second 24 legs that extend downwardly from the base portion 20. The first 22 and second 24 legs are positioned on opposing lateral side edges of the free end 12b of the leaf spring 12. A contact element 30 is supported by the slider bracket 18 and cooperates with the free end 12b to accommodate vertical forces.

The free end 12b of the leaf spring 12 can slide relative to the contact element 30 along a longitudinal axis as indicated at arrow 32 and/or can pivot relative to the contact element 30 about a lateral axis as indicated at arrow 34. In the example shown in FIG. 2, the contact element 30 comprises a cam 36 having a curved surface 38 that contacts an upper surface 40 of the free end 12b of the leaf spring 12.

The cam 36 is comprised of a resilient material such as a polymeric or elastomeric material, and is covered with a layer of wear resistant material to improve wear life. The wear resistant material should have a certain level of compliance to create a large load foot print with the mating leaf spring 12. The stiffness of the cam 36 can be tailored to mimic traditional steel cams, which provide for a variable spring rate by modifying an effective spring length. The cam 36 can be ribbed (see dashed lines 42) and/or hollowed (see dashed lines 44) to provide variable stiffness to accommodate spring angular displacement at the free end 12b, while still maintaining a large load foot print.

A rebound bolt 46 is also fixed to the slider bracket 18. The contact element 30 is positioned vertically above the free end 12b while the rebound bolt 46 is positioned vertically below the free end 12b by a gap, which is shown exaggerated for clarity purposes. The rebound bolt 46 defines a vertical stop for the free end 12b during a rebound event. The rebound bolt 46 can be moved vertically closer to the free end 12b and/or a rubber tube 48 can be used to surround the rebound bolt 46 to maintain the free end 12b in contact with the contact element 30 depending upon the vehicle application and desired performance characteristics.

Another example of a contact element 30 is shown in FIG. 3. In this example, the contact element 30 comprises a pivoting cam 50 that is coupled to a pivot pin 52, which is fixed to at least one of the first 22 and second 24 legs of the slider bracket 18. Please note that the second leg 24 is not shown in FIG. 3 for clarity purposes. The pivoting cam 50 has a generally triangular shape and includes a generally flat base surface 54 that faces the upper surface 40 of the free end 12b. Angled side surfaces 56 extend from the base surface 54 to an apex 58 that supports the pivot pin 52.

Like the cam 36 discussed above, the pivoting cam 50 is formed from a resilient material such as a polymeric or elastomeric material, for example. A pad or layer of wear resistant material 60 is bonded to the base surface 54 for direct contact with the upper surface 40. Again, the wear resistant material should have a certain level of compliance to create a large load foot print with the mating leaf spring 12. Further, the free end 12b of the leaf spring 12 can slide relative to the pivoting cam 50 along the longitudinal axis as indicated at arrow 32 and/or can pivot relative to the pivoting cam 50 about the lateral axis as indicated at arrow 34.

The cams shown in the examples above can be molded directly onto the slider bracket 18 to simplify assembly. The cams are configured to support the vertical forces on the leaf spring 12 and to distribute these vertical forces over a large area to reduce pressure and wear accordingly.

Another example of a contact element 30 is shown in FIG. 4. In this example, the contact element 30 comprises a cam formed as a roller 62. The roller 62 is positioned vertically above the free end 12b and is fixed to at least one of the first 22 and second 24 legs of the slider bracket. Again, the second leg 24 is not shown for purposes of clarity. The roller 62 is formed from an elastomeric or polymeric material and can include a wear resistant layer or coating. The roller 62 can be used with a rebound bolt 48 as shown in FIGS. 2-3, or the rebound bolt could be replaced with a second roller 64. The second roller 64 is positioned vertically below the free end 12b and is formed from a polymeric or elastomeric material that may have a lower stiffness property than that of the upper roller 62. This softens rebound events. Again, the free end 12b of the leaf spring 12 can slide relative to the rollers 62, 64 along the longitudinal axis as indicated at arrow 32 and/or can pivot relative to the rollers 62, 64 about the lateral axis as indicated at arrow 34.

Another example of a contact element 30 is shown in FIG. 5. In this example, the contact element 30 comprises a resilient block 70 that is made from an elastomeric material, such as rubber for example. The resilient block 70 is bonded to at least one of the first 22 and second 24 legs of the slider bracket 18, and can also be bonded to the base portion 20. In this example, the second leg 24 and base portion 20 are not shown for purposes of clarity. The free end 12b of the leaf spring 12 can slide relative to the resilient block 70 along the longitudinal axis as indicated at arrow 32 and/or can pivot relative to the resilient block 70 about the lateral axis as indicated at arrow 34.

The resilient block 70 includes a plurality of holes 72 that extend in a lateral direction. The holes 72 can be formed to have different diameters and spacing patterns to tune/control vertical stiffness depending upon desired characteristics. In the example shown, the holes 72 are formed in a pattern that is distributed away from a center 74 of the resilient block 70 such that vertical stiffness is greater at the center 74.

Additionally, side pads 76 can be mounted to the first 22 and second 24 legs of the slider bracket 18 to increase lateral stiffness. The side pads 76 can be formed from a polymeric or elastomeric material and coated with a wear resistant material. The side pads 76 are positioned very close to the lateral side edges of the free end 12b such that there is minimal lateral play. In one example, the free end 12b is press fit between the two side pads 76. The side pads 76 can be molded as one piece with the slider bracket 18 to simplify assembly.

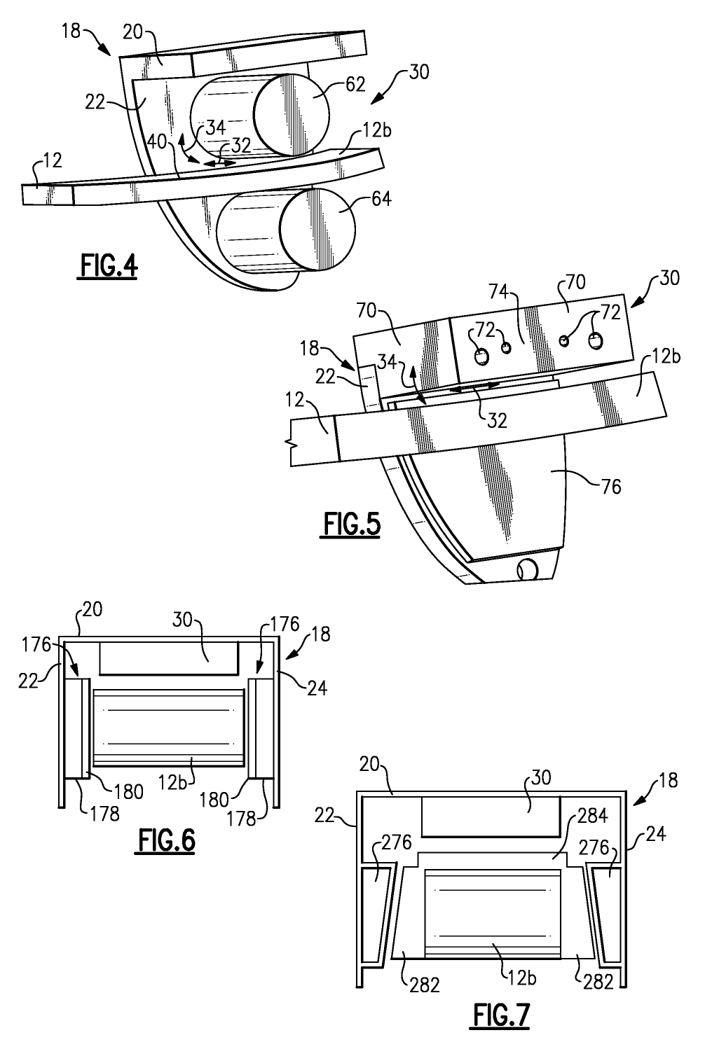

FIGS. 6 and 7 show other examples of side pads 76. FIG. 6 shows an example where side pads 176 are formed from a resilient layer 178 and include a wear resistant layer 180. The example of FIG. 7 shows side pads 276 that are wedged shaped and which contact similarly shaped side pads 282 attached to the free end 12b. A top pad 284 could also be attached to the upper surface 40 to engage the contact element 30. These pads 282, 284 could be formed from an ultra high molecular weight polyurethane, for example, to provide good wear characteristics. It should be noted that the contact elements 30 in FIGS. 6 and 7, which are positioned above the free end 12b, can be a resilient block or cam as described in any of the examples set forth above. Further, the side pads described above could be utilized with any of the cam or block embodiments discussed above.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A suspension spring assembly comprising:
an elongated composite spring body having a central portion to be supported by an axle and at least one free end extending away from said central portion in a longitudinal direction;
a slider bracket to be mounted to a vehicle structure, said slider bracket cooperating with said at least one free end such that said at least one free end is movable relative to said slider bracket; and
a contact element mounted within said slider bracket for contacting at least an upper surface of said at least one free end to accommodate vertical forces of said elongated composite spring body, said contact element cooperating with said elongated composite spring body to allow said elongated composite spring body to slide relative to said contact element in the longitudinal direction and to allow said elongated composite spring body to pivot about a lateral axis relative to said contact element.

2. The suspension spring assembly according to claim 1 wherein said contact element comprises a resilient member that is fixed to said slider bracket, and wherein said at least one free end is pivotable about said lateral axis and slidable along said longitudinal direction during contact with said resilient member.

3. The suspension spring assembly according to claim 1 wherein said contact element comprises a cam formed from a resilient material.

4. The suspension spring assembly according to claim 3 wherein said resilient material comprises an elastomeric material, and wherein said cam includes a curved surface that is covered with a layer of wear resistant material.

5. The suspension spring assembly according to claim 3 wherein said cam comprises a pivoting cam coupled to a pivot pin, said pivoting cam having a generally flat lower surface covered by a wear resistant pad that engages said upper surface of said elongated composite spring body when experiencing vertical forces.

6. The suspension spring assembly according to claim 3 wherein said slider bracket comprises a U-shaped component having a base portion with first and second legs extending downwardly from said base portion on opposite sides of said at least one free end, and wherein said cam is mounted to said base portion to accommodate vertical forces and includes first and second pads mounted to inwardly facing surfaces of said first and second legs to provide lateral stiffness.

7. The suspension spring assembly according to claim 3 wherein said cam comprises a first roller positioned vertically above said at least one free end and a second roller positioned vertically below said at least one free end.

8. The suspension spring assembly according to claim 7 wherein said first roller is formed from a first material having a first stiffness and said second roller is formed from a second material having a second stiffness that is less than said first stiffness.

9. The suspension spring assembly according to claim 1 wherein said contact element comprises a resilient block formed from an elastomeric material.

10. The suspension spring assembly according to claim 9 wherein said resilient block includes a plurality of holes that are spaced apart from each other in a longitudinal direction and which are distributed away from a center of said resilient block to control vertical stiffness.

11. The suspension spring assembly according to claim 1 including a rebound element fixed to said slider bracket at a position vertically below said at least one free end, wherein said rebound element defines a vertical stop during a rebound event.

12. A method of coupling a composite leaf spring to a slider bracket comprising the steps of:
(a) forming an elongated spring body from a composite material where the elongated spring body includes a central portion to be supported by an axle and at least one free end extending from the central portion in a longitudinal direction;
(b) orientating the at least one free end relative to a slider bracket such that the at least one free end is movable relative to the slider bracket; and
(c) mounting a contact element to the slider bracket to contact at least an upper surface of the at least one free end of the elongated spring body to support vertical forces, the contact element allowing the at least one free end to slide relative to the contact element along a longitudinal axis and rotate relative to the contact element about a lateral axis.

13. The method according to claim 12 including forming the contact element to include laterally spaced pads on the slider bracket that are mounted adjacent opposing lateral side edges of the at least one free end to provide lateral stiffness.

14. The method according to claim 13 including forming the contact element as a cam.

15. The method according to claim 14 including forming the cam from an elastomeric material that is covered with a layer of wear resistant material.

16. The method according to claim 15 including forming the laterally spaced pads from an elastomeric material that is covered with a layer of wear resistant material.

17. The method according to claim 12 including forming the contact element as an elastomeric block, forming a plurality of laterally extending holes within the elastomeric block, and distributing the plurality of laterally extending holds away from a center of the elastomeric block in a specified pattern to provide a desired vertical stiffness.
